(19) United States
(12) Patent Application Publication
(10) Pub. No.: US 2010/0000405 A1
(43) Pub. Date: Jan. 7, 2010

(54) METHOD OF TREATING COMBUSTION GASES

(75) Inventors: Michael Thomas Greiner, Fayetteville, GA (US); Grahame Peter Higgs, Queensland (AU); Robert Cunningham Gardiner, Queensland (AU); Inia Wharengarangi Timu, Western Australia (AU)

Correspondence Address: KNOBBE MARTENS OLSON & BEAR LLP, 2040 MAIN STREET, FOURTEENTH FLOOR, IRVINE, CA, 92614, US

(73) Assignee: Green Leader Technologies Pty Ltd., Brisbane , Queensland (AU)

(21) Appl. No.: 12/302,753

(22) PCT Filed: May 25, 2007
(86) PCT No.: PCT/AU2007/000730

§ 371 Date: Apr. 21, 2009

(30) Foreign Application Priority Data
May 26, 2006 (AU) 2006902853

(51) Int. Cl. B01D 53/14

(52) U.S. Cl. 95/13; 95/149; 95/154; 95/16; 95/23; 95/236; 95/235; 95/232; 96/256; 96/251

(57) ABSTRACT

A method of treating exhaust gases is described comprising the introduction of a treatment composition including or comprising a micelle encapsulating compound. A preferred embodiment the treatment comprises by volume; from about 4 to about 40 parts of an alkoxylated C₁₆-C₁₈ tertiary amine surfactant, from about 1 to about 15 parts of at least one carboxylic acid having from 4 to 16 carbon atoms; about 1 to 6 parts of at least one of a C₆-C₁₄ alcohol, from 0 to 10 parts of a C4 and lower alcohol, with the balance being water to create a total of about 100 parts by volume. The treatment composition may be introduced into a confined flow path for exhaust gases at a rate of 0.1 to 6% although a range above and below that may be suitable. The invention also extends to a system for treating exhaust gases comprising a confined flow path for the exhaust gases and an application arrangement for applying a treatment composition comprising or including a micelle encapsulating surfactant.

### FIELD OF THE INVENTION

The present invention relates to a method of treating combustion gases including but not limited to a column of smoke. The invention relates to a method of introducing a chemical composition to combustion gases in or near a confined flow path, for example, a chimney or smoke stack. The invention may extend to an arrangement designed to introduce a preferred chemical into a flow path for combustion gases. The method and arrangement may be particularly well suited to reducing carbon dioxide in exhaust gases but it not so limited and may extend to reduction of carbon monoxide, sulphur dioxide, and nitrogen oxide and other contaminants.

### BACKGROUND OF THE INVENTION

With increasing industrialisation, the issue of air pollution has adopted greater significance over time. Not only does the quality of air impact on the ordinary wellbeing of citizens, it can result in serious and even fatal consequences to people adversely affected by toxic or irritant atmospheric contaminants. These people may have predisposing characteristics such as the presence of asthma or respiratory diseases. It is not unknown for a heavily polluted atmosphere to act as the primary instigation of disease and/or dyspnoea in people. Further, the effects of increased atmospheric pollution have given rise to the worldwide threat of global warming. Many scientists are predicting catastrophic consequences if the effects of global pollution and global warming are not confronted immediately and aggressively. Even with a aggressively. Even with a vigorous response, there may be dire consequences for some inhabitants of low lying areas should the ice sheets of the Arctic and Antarctic regions commence to melt, as predicted by some commentators.

Air pollution is a result of many inputs including vehicle exhaust emission, coal burning, especially in power stations, internal combustion engines other than vehicles, and grazing animal eructation. There is an additional contribution provided by the present widespread deforestation of pristine wildernesses, which have until now acted as remedial treatment sinks for the atmosphere. One of the major, if not the most significant, of these impacts on air pollution is the accumulative effect of exhaust gases produced from combustion, particularly associated with industry. Massive amounts of pollution result from coal fired power stations. These power stations are renowned sources of long term damage to the atmosphere. Complicating factors have arisen from the industrial development of countries such as China and India. One of the earliest requirements in this industrialisation process is the need for power. Electrical power is used to both drive manufacturing plants and improve the lifestyles of citizens. A direct result of this increasing industrial capacity is the discharge into the atmosphere of large amounts of potentially harmful material. While the Kyoto Protocol evidences an intention of the signatory nations to address the issue, there is a constant need to find feasible, practical and cost effective methods of contributing to the process of lowering emission levels, particularly but not exclusively, in smoke.

There have been some attempts to provide arrangements and methods for cleaning smoke columns. These are often associated with very high technological approaches and great expense. Alternatively, cheaper approaches such as simply spraying water into smoke are often at times relatively ineffective and may lead to problems with the residual liquid having high levels of noxious substances.

U.S. Pat. No. 5,945,026 is for an invention directed to composition and methods for fire fighting hydrocarbon fires. The disclosure of the document is to a biodegradable non-toxic fire fighting concentrate composition. The preferred compositions include 4 to 40 parts of a C16-C18 tertiary amine having 2-10 ethoxy or other solubilising groups per mol, 1 to 15 parts of a carboxylic acid having 6 to 16 carbon atoms, 1 to 6 parts of a C6-C16 and 0 to 10 parts of C4 and lower alcohols, and enough water to create a total of 100 parts per volume. This concentrate may be diluted up to 100 times (V/V) with water, and is also effective when mixed with foam forming materials. In addition, the composition is useful for soil bacteria for remediating soil contaminated with hydrocarbon fuel and facilitating fuel dispersion and degradation within bacterial action sewage system.

Related U.S. Pat. Nos. 6,645,390, 6,139,775, 6,645,391, 6,740,250 are all to the same applicant. All specifications referred to in this document are incorporated herein by reference.

The inventors of the above patented technologies have described a very useful product through a range of different embodiments, which is used for application to hydrocarbon fuel fires or to disperse hydrocarbon spills in the the environment. Various examples are provided of test fires that are extinguished using the product of the invention either alone or in company with a foaming agent.

The applications are restricted to use on fires and for bioremediation, including the removal of non-aqueous phase liquid from surface and ground waters. The examples include use as a bioremediation agent on diesel fuel spillage wherein the concentrate attacked and dispersed fuel. While the identified and explained chemicals are excellent in the indicated application, there is no indication of suitability for other purposes.

No reference in any prior art documentation is any form of connection or acknowledgement that such documentation forms part of the common general knowledge in Australia or elsewhere.

### SUMMARY OF THE INVENTION

In a first broad form, the invention resides in a method of treating exhaust gases, the method comprising the steps of:

introducing a treatment composition in a controlled manner to exhaust gases in or near a confined flow path;

wherein:

the treatment composition includes or comprises a micelle encapsulating compound.

The micelle encapsulating compound may comprise or include an anionic surfactant.

Introducing the treatment composition in a controlled manner may include one or more of:

varying the concentration of treatment composition by the addition of water;

varying the rate of introduction of the treatment composition to the exhaust gases;

using sensors to assess one or more of temperature, concentration and flow rate of the exhaust gases and subsequently modifying one of the other characteristics to better treat the exhaust gases.

The step of sensing the parameters may include the step of providing data to a computer and wherein varying the parameters is controlled by the computer in accordance with one or more algorithms.

In yet a further aspect, the invention resides in a method of treating exhaust gases, the method comprising the steps of:

introducing a treatment composition in a controlled manner to exhaust gases in or near a confined flow path;

the treatment composition comprising by volume, from about 4 to about 40 parts of an alkoxylated C₁₆-C₁₈ tertiary amine surfactant, from about 1 to about 15 parts of at least one carboxylic acid, preferably aliphatic, having from 4 to 16 carbon atoms; about 1 to 6 parts of at least one of a C₆-C₁₄ alcohol, preferably aliphatic, from 0-10 parts of a C₄ and lower alcohol, and the balance being water to create a total of about 100 parts of volume, or a compound of a similar type.

The surfactant preferably has 2-10 alkoxy groups per mol. The surfactant is preferably selected from animal-based tallow amines and coconut amines

In yet a further aspect, the invention resides in a method of treating exhaust gases, the method comprising the steps of:

introducing a treatment composition in a controlled manner to exhaust gases in or near a confined flow path;

the treatment composition comprising, by volume from about 4 to about 40 parts of an ethoxylated C₁₆-C₁₈ tertiary amine, having 2-10 ethoxy groups per mol, from 1 to about 15 parts of at least one aliphatic carboxylic acid, having from 6 to 12 carbon atoms; about 1 to 6 parts of at least one of a C₇-C₁₂ aliphatic alcohol, from 0 to 10 parts of a C₄ and lower alcohol, and the balance being water, to create a total of about 100 parts by volume or, alternatively,

One preferred treatment composition comprises 2,2,2-nitrotrisethanol aliphatic acid soap in a proportion of around 9.9%,

amines, tallow alkyl ethoxylated 2-etholhexanonates in a proportion around 45%,
linear aliphatic alcohols in a proportion around 5.1%
water in a proportion around 40% to give a total of 100%.

The method preferably includes the step of diluting the treatment composition which may be provided as a concentrate. The step preferably includes the step of diluting the treatment composition to a preferred range of 2-6%, preferably 3-6% and most preferably 3% or 6%. Diluting the treatment composition may include the step of adding water. The treatment composition may be diluted with water up to 10,000 parts of water per part of chemical composition concentrate but preferably up to 1000 parts of water. Applying the treatment composition may include one or more of spraying, bubbling, misting, hosing, dripping or mixing the treatment composition into or through the exhaust gases in or near the confined flow path. Near the confined flow path refers principally to a location adjacent an exit. Applying the treatment composition may include the step of applying the treatment composition in a treatment region of the flow path. The method may further include collecting any precipitate formed from the method and further treating it, disposing of it or storing it. The exhaust gases are preferably from a combustion of hydrocarbon fuel source but are not necessarily so limited.

The confined flow path may be formed in a stack, chimney, an exhaust system of a vehicle or other suitable arrangement.

In still a further aspect the invention may reside in a method of treating exhaust gases for reduction of one or more of carbon dioxide, carbon monoxide, sulphur dioxide, nitric oxide and NO_{X}, the method comprising the steps of:

introducing a treatment composition comprising, by volume; from about 4 to about 40 parts of an alkoxylated C₁₆-C₁₈ tertiary amine surfactant, from about 1 to about 15 parts of at least one carboxylic acid having from 4 to 16 carbon atoms; about 1 to 6 parts of at least one of a C₆-C₁₄ alcohol, from 0 to 10 parts of a C₄ and lower alcohol, with the balance being water to create a create a total of about 100 parts by volume. The method may further include the step of diluting the treatment composition with water, preferably to a concentration range of 0.1% to 6%, most preferably 1% to 6%.

In a further aspect, the invention may reside in a system for treating exhaust gases, the system comprising:

a confined flow path for exhaust gases;

an application arrangement for applying a treatment composition to the exhaust gases in the confined flow path; and

storage for storing the treatment composition, the storage in liquid communication with the application arrangement, wherein:

the treatment composition comprises one or more of the compositions described above.

The confined flow path may comprise a stack, a chimney, an ancillary chamber, a vent or an exhaust system of a motor vehicle or other internal combustion device.

The application arrangement may comprise a pressurised application system adapted to provide a mist, a spray, a fog, a jet or droplets.

### BRIEF DESCRIPTION OF THE DRAWINGS

FIG. 1 is a schematic view of an arrangement of the present invention for washing smoke stack contents; and

FIG. 2 is a schematic view of a second part of the arrangement of FIG. 1.

### DETAILED DESCRIPTION OF THE PREFERRED EMBODIMENTS

The present invention is directed to treatment of gases produced by combustion. In a preferred embodiment, a concentrated treatment composition is formed by 2,2,2-nitrotrisethanol aliphatic acid soap 9.9%, amines, tallow alkyl, ethoxylated 2-etholhexanonates 45%, linear aliphatic alcohols 5.1% and water 40%. This compound is one of the group known as micelle encapsulators. Without binding the applicant to any one theory, it appears the micelle encapsulators function by nature of their molecular structure. They have the ability to form a cocoon (micelle) around a molecule of the target substance. The fluid chosen for the smoke wash experiments include molecules which are polar/hydrophilic at one end (the head) and non-polar/hydrophobic at the other (the tail). The two are sufficiently separated from each other to be able to act independently. The non-polar tail is repelled by water and seeks a hydrocarbon molecule. Sufficient non-polar tails will surround the hydrocarbon molecule forming a sphere or other envelope with the hydrocarbon molecule at the core. The polar heads of this sphere seek water and thereby the isolated molecule, such as a hydrocarbon molecule, may be held in suspension in a solution of the wash fluid.

Of the micelle encapsulator compounds available, experiments were conducted using a commercially available product known as F-500 available from Environmental Hazard Management Pty Ltd of Level 2 Terminal Building, Grenier Drive, Archerfield Airport, Archerfield, Queensland 4108, Australia. However, the invention may extend beyond the use of this compound alone and may extend to other and even all micelle encapsulators.

Part of the present activity appears to arise from the surfactant capacity of the treatment composition.

Surfactants are also known as surface-active agents because they concentrate at interfacial regions like air-water, oil-water, and solid-liquid interfaces. The surface activity of surfactants is due to their amphiphilic nature. Such molecules contain one soluble and one insoluble moiety. Surfactants may dissolve in water as a monomer, adsorb at an interface, or be incorporated with other surfactant molecules as a part of micelle. In aqueous systems, a surfactant has a polar hydrophilic moiety and a non-polar hydrophobic moiety, referred to as the head and tail groups, respectively. The ability of surfactants to act as wetting and solubilizing agents has made them especially applicable in various industrial and commercial products such as household detergents, stabilizers for drilling mud, and emulsifiers in paints, pesticides and some foods.

Surfactants are classified according to the nature of the hydrophilic (or head) portion of the molecule. If the head carries a negative charge, the surfactant is termed anionic. Surfactants with positively charged heads are termed cationic. Those surfactants with both positive and negative charges on their heads are termed zwitterionic and surfactants which carry no charge on their heads are termed non-ionic. Prominent chemical differences between surfactants are due to their head groups.

A feature unique to surfactants is the ability to aggregate into dynamic clusters, called micelles, in aqueous media. Surfactants usually exist in their monomeric form at concentrations less than a compound specific threshold value, referred to as the critical micellar concentration. Below this concentration some fraction of the surfactant adsorbs at system interfaces. The CMC represents a narrow concentration range over which the partial derivatives of many solution properties (i.e. surface tension) display abrupt changes in value with respect to surfactant concentration. Solubilization of hydrophobic compounds commences at the CMC and is a linear function of surfactant concentration. In a micelle, individual monomers are oriented with their hydrophilic moieties in contact with the aqueous phase and their hydrophobic moieties oriented toward the interior of the aggregate. These nonpolar moieties spontaneously associate with each other in the process of micellization to form various geometrical volumes including spheres and spheroids.

In this specification a micelle encapsulating compound comprises or includes a surfactant, preferably non-ionic, that forms micelles and may cause solubilization of hydrophobic compounds.

F-500 is promoted as a surfactant-based fire fighting, tank-cleaning and remedial agent. The concentrate treatment composition may be diluted, preferably with water. The preferred range for dilution is to provide concentrate in water at a V/V percentage of 2-6%. A particularly preferred range is 3-6%. The preferred concentrations are around 3% or around 6%. However other concentrations may be used. It has been found that a concentration of 0.01% is effective but slow. A preferred range is 0.1% to 6% and particularly around 1%, 3% or 6%. Other concentrations may be suitable for use. Non limiting examples include 0.05%; 0.2%, 0.5%, 0.8%, 2%, 4%, 2%, 4%, 8%, 10%. The ranges may include any range between any two of the preceding values.

The present invention is particularly useful for the treatment of exhaust gases in the nature of smoke from hydrocarbon combustion.

The treatment composition is added at a location spaced from the source of combustion to prevent its fire retardant qualities interfering with that combustion.

The treatment composition may be provided as a mist to intermix with the stream of combustion gases in the flow path. A preferred flow path is a stack, chimney or other venting apparatus for a fire such as a coal fire. These sources of emission have been renowned for polluting the atmosphere. The present method is particularly well suited to treat and improve the quality of the smoke emission from coal fired furnaces. However, it should be noted that application of the present invention is not so limited. It is within the scope of the invention to extend to other combustion arrangements wherein a combustion chamber connects with a confined flow path for the discharge of combustion gases.

### EXAMPLES

A stainless steel combustion chamber was erected to house combustible material and to support a series of three chimney sections that could be added or deleted as required. The chimney sections included apertures through which the liquid treatment composition could be introduced into the exhaust gases in or near the confined flow path which could be configured with different heights.

The treatment composition comprised 2,2,2-nitrotrisethanol aliphatic acid soap in a proportion of around 9.9%, amines, tallow alkyl ethoxylated 2-etholhexanonates in a proportion around 45%, linear aliphatic alcohols in a proportion around 5.1% and water in a proportion around 40% to give a total of 100%. Reference to F-500 in this specification is reference to this composition.

The application means in this case was a portable pressure canister with a spray wand which was used to introduce the treatment composition at preselected varied dilution percentages.

The combustion chamber was designed to allow a burning of chosen material. Combustible material was chosen to provide a clearly visible smoke plume. A variety of substances were used and included diesel fuel, rubber, polystyrene, wood and several plastics.

### Example 1

The treatment composition (F-500) was diluted initially to a 3% solution V/V in water. Combustion was commenced in the chamber. The treatment composition was introduced into the smoke plume immediately on exit from the chimney. There was a 24 knot wind blowing. The diluted treatment composition spray mixed well with the smoke as it exited from the chimney. The smoke turned rapidly from thick black to a less dense light grey/white colour virtually immediately at the point of solution introduction. Visual acuity through the smoke colour change was improved by a factor of at least 50%. It is important to note the treatment composition was applied to the smoke remote from the site of combustion.

### Example 2

The same steps as Example 1 were effected, except that a 6% of the dilution treatment composition was used. This resulted in similar or identical results to Example 1. A lack of appreciable difference in performance between the 3% and 6% solutions appears to be a result of the volume of smoke within the processing capacity of the lesser 3% solution. It is envisaged that a greater smoke level output will require more volume and/or concentration of the treating liquid.

Without binding itself to a view, the applicant believes the colour change may indicate the fact that hydrocarbon molecules and the particulate matter in the smoke were being subjected to micelle encapsulation, rendering them inert and trapped. Further indications are that at least some of the sulphur contained in the smoke is also subject to micelle encapsulation. It is believed the present method may result in reduction/elimination of one or more particulate matter, volatile organic compounds, carbon dioxide, carbon monoxide, sulphur dioxide, sulphur trioxide, nitrogen dioxide, nitric oxide, hydrogen sulphide, polycyclic aromatic hydrocarbons, dioxins, heavy metals and other materials.

Although a range of pollutants are expected to be beneficially reduced or removed, it was considered that a significant reduction of CO₂ alone would be advantageous.

The trial was directed to obtaining data on the reduction of Carbon Dioxide (CO₂) from the uniform effluent created by burning diesel fuel as a primary objective. A secondary objective was to seek results from burning black coal should indications prove warranted.

### Example 3

300 ml of diesel fuel was placed in a crucible within a stainless steel burner and ignited. The resultant smoke was funnelled into a 125 mm×1000 mm stainless steel chimney. The overall height of the burner/chimney unit was 1700 mm with a sampling port in the chimney 1200 mm above the crucible and well within the smoke stream.

Smoke was scavenged from inside the chimney at a point above and close to the sampling port by sucking the effluent into an 80 mm diameter funnel through a 30 mm pipe and reinforced hose into the washing chamber. A 12 volt induction fan was wired via a three speed switch and a rheostat. This combination gave comprehensive control of the fan speed and ensured that a positive flow of effluent was constantly delivered throughout the apparatus.

The washing chamber was a 90 mm×1500 mm tube fitted with three micro mist spray nozzles. These were fed a 3% solution of washing fluid via a pressure pump. This 12 volt pressure pump was wired via a three position switch giving a degree of control over the volume of fluid delivered to the mist nozzles.

Following the washing process the remaining gas was directed through a U tube (to collect any residual moisture) into the sampling chamber, from there into a visual observation chamber and finally through a non-return valve into the atmosphere. An extraction fan was fitted between the sampling chamber and the observation chamber to provide additional positive gas flow positive gas flow if needed. To ensure complete mixing, the post-wash sampling port was located 1900 mm down stream from the third misting nozzle i.e. well in excess of 3× the diameter of the washing chamber. (3×125=375 mm).

Following the misting process the wash fluid was collected in a U bend configuration below the washing chamber. This had the dual purpose of sealing the washing chamber from the atmosphere and providing a point from where a sample of used fluid could be drawn for analysis. The downstream end of the U bend was vented to the atmosphere at a level that retained the seal to the washing chamber at a constant level while allowing overflow residual fluid to be collected for further use if necessary. This configuration automatically prevented the washing chamber from becoming flooded irrespective of the volume of wash fluid delivered by the pressure pump.

Sampling and Analysis

Gas sampling and analysis was conducted using a Drager Tube system which not only ensured a uniform metered dose could be drawn in each case, but also gave an instant readout of concentration from the reaction with the tube contents.

Sampling was conducted at three points:
1. The chimney port;
2. Immediately after the induction fan but prior to the wash chamber; and
3. The post-wash sampling port.

Diesel—CO₂

Results were obtained until the Drager Tubes clogged up with soot prior to the full metered sample cycle being completed. The results obtained up to the point of complete obstruction when compared to the post-wash results, were sufficient to draw conclusions in support of the process.

Chimney Port: At the point of full obstruction, the Drager Tube registered a value of 6% Vol. Although not completed, this value occurred at a point close to the full sample cycle and is considered to be reasonably indicative of the minimum CO₂ concentration of raw diesel smoke. In an endeavour to capture a reading without the Drager tube becoming obstructed, a sample was taken in the flow at the top of the chimney. A full sample cycle was not completed by the sampling pump but again stopped close to the full cycle. The concentration indicated well beyond 6%, the percentage capacity of the tube.

The visual assessment of smoke from the chimney was considered to be Ringelmann 3 i.e. 60% black.

Induction Fan Port: Due to the concentration of smoke i.e. from 125 mm bore, to 30 mm bore, the Drager Tube obstruction occurred quite rapidly. The reading at the point of obstruction was in excess of 2.5% Vol but, as this occurred at a point approximately one third into the metered sample cycle; this reading is not considered reliable.

Post Wash Port: To ensure that the wash chamber was free of unprocessed smoke, and an uncompromised sample could be acquired, the wash process was allowed to run five minutes prior to the sample being taken. With the pressure pump on the lowest setting and a continuous positive flow of gas from the non-return valve, a full metered sample was taken at the post-wash port. The Drager Tube remained entirely free of soot. This reading was 1.5% Vol which is consistent with samples taken at various times during the development of the apparatus. The visual clarity of the smoke discharged at the non-return valve was below Ringelmann 1 (20% black).

Residual Wash Fluid: The used wash fluid was collected and a sample taken for analysis. Of the remaining fluid, a change in colour was immediately evident, having changed from a light milky off white to a dark charcoal grey. This indicated that a substantial percentage of particulate matter was suspended in the post wash fluid.

As a comparison, without changing the smoke induction fan settings or the mist spray settings, the apparatus was run for ten minutes using plain water as a misting fluid. At the end of this time a further residual spray sample was taken.

Both samples were sent to a commercial laboratory for analysis. The results were as follows:

Post Wash Fluid Particulate Count 8 mg/L

Post Wash Water Particulate Count <1 mg/L

### Example 4

### Coal

### CO₂

The experiment was repeated using black coal from Ipswich, Queensland, as the combustible material. Again samples were taken from the the three ports identified above. The smoke from the coal fire was considerably less dense compared to the diesel smoke and no difficulty was experienced obtaining samples via the Drager Tubes.

Chimney Port: A sample of the emission produced by the coal fire was successfully taken from the chimney port and indicated a reading of 0.8% Vol. The visual presence of smoke was assessed at between Ringelmann 1 and Ringelmann 2.

Induction Fan Port: The sample taken at the induction fan port produced a reading of 0.79% Vol. The visual appreciation of smoke was Ringelmann 1.

Post Wash Port: The sample taken at the post wash port produced a reading of 0.6% Vol. Although it was possible to feel a positive out flow from the non-return valve, there was no identifiable smoke discolouration to measure.

Residual Wash Fluid: Once again the residual post wash fluid was collected and again a colour change was evident. In this case the fluid had changed from light milky off white to a dirty light grey. Again this indicated a level of particulate matter suspended in the fluid and although not as dark as the result from the diesel smoke, this result was consistent with the original opacity difference between the subject smokes.

The initial version of the device was trialled exclusively on coal fires and involved variations of misting the wash fluid directly into the chimney. Although some results were achieved, too many variables burning coal and the difficulty of working with a hot environment prevented the collection of collection of consistent data of reliable quality. Of the results gained however, when compared with those from a later generation apparatus where heat was not an issue, it was evident that the efficiency of the wash fluid on coal smoke was improved by an increase in temperature. This prompted further experiments to investigate the implications of heating the fluid.

Diesel:

Experiments to remove CO₂ from burning diesel produced results ranging from a 62% to a 75% reduction. Additionally the ability to remove sooty particulate matter from diesel smoke is substantial.

Black Coal:

Experiments to remove CO₂ from burning black coal produced results varying from 24.69% to 52% removed. This variance is thought to be dependant on the temperature of the wash fluid however, is sufficient to deduce that the process, though yet to be quantified on black coal, is nevertheless effective. Additionally, the ability to improve the opacity of black coal smoke is very significant.

From the number and nature of the experiments conducted, there is no doubt that the introduction of a micelle encapsulation wash fluid removes at least some carbon dioxide from coal and diesel smoke to a greater or less degree. Additionally the fluid has the ability to remove a high level of particulate matter from the subject smoke. The post wash samples were allowed to stand undisturbed for two weeks. After this time, it was observed that the particulate matter had remained in suspension with no formation of sediment. Moreover, because no exothermic activity was experienced during washing and following professional consultation and without binding the applicant to any one or more theory on the operation of the process, it is considered that the process may be one of adsorption.

From the present test results, the introduction of the treatment composition into smoke has a beneficial effect on its visual pollution and carbon dioxide emissions. There is also evidence to indicate that the substance may work by micelle encapsulation and will reduce or remove unburnt hydrocarbon and sulphur from smoke. These advantages provide an ability to control, minimise or reduce harmful pollutants that would otherwise be discharged into the environment, thereby combatting broad scale effects such as global warming.

Control of the treatment composition may include varying the dilution rate of the composition concentrate. It may even be possible to vary the rate and temperature in a single installation to accord with the type, volume and risk of a particular smoke plume. A similar variability may be built into the volume of diluted treatment composition provided into the confined flow path or at or around its exit.

### Example 5

Experiments were conducted to assess the reduction of CO2 from coal effluent. This was seen as a primary goal with a reduction of CO, SO2, NO and NOx identified as additional desirable goals.

An apparatus was designed, constructed and progressively developed over three years to determine the degree of target pollutants that could be reasonably removed by the present invention, termed a Pollution Encapsulation Process (PEP).

The preferred wash fluid was a proprietary compound F-500 acquired from Green Leader Technologies Pty Ltd of Brisbane Queensland.

Two fossil fuels were chosen for analysis, black coal from Ipswich Queensland, and for an independent series of experiments, commercial Diesel fuel.

Additional experiments using Food-Grade CO2 were conducted to determine the degree and nature of adsorption of CO2 by the treatment composition.

### Combustion Apparatus

The apparatus for combustion experiments consisted of three main components:

### Burner

The burner was a 535 cm diameter×460 cm high, stainless steel drum, fitted with a brazier and an air blower to aid combustion. A length of 125 mm flexible aluminium flue ducting was used to direct all the burner output into the processing unit.

### Processing Unit

The processing unit comprised one 100 mm×1000 mm chamber fitted with three misting sprays and one 100 mm×850 mm wash chamber fitted with a single misting spray. A U-bend configuration residual capture unit was configured below each washing chamber. This had the dual purpose of sealing the washing chamber from the atmosphere and providing a point from a point from where a sample of used fluid could be drawn for analysis. The downstream end of the U-bend was vented to the atmosphere at a level that retained the seal to the washing chamber at a constant level while allowing overflow residual fluid to be collected for further use if necessary. This configuration automatically prevented the washing chamber from becoming flooded irrespective of the volume of wash fluid delivered by the spray nozzles.

The Sampling Chamber was a 100 mm×1300 mm tube fitted with a clear observation window and a sampling port 1150 mm from the fourth spray nozzle. The clear window was necessary to monitor and avoid fouling of a Unigas 3000+ probe and the position of the sample port satisfied the requirements for a thoroughly mixed sample while reducing the likelihood of the analyser probe becoming contaminated.

A 12 volt electrical circuit was designed to provide power to a 200 psi pump, 100 watt air blower and a rheostat controlled extraction fan which was fitted at the exhaust end of the apparatus to ensure positive flow through the system.

A new calibrated Unigas 3000+ Flue Gas Analyser configured to measure O₂, CO2, CO, SO2, NO and NOx was utilised for gas analysis.

### Method

Raw output was ducted from the burner directly into the processing chamber where it was exposed to a micro mist of wash fluid delivered via a series of four ceramic spray nozzles fed by a high pressure pump. The two upstream spray nozzles operated in unison while the mid and downstream nozzles were individually selectable. A sample port was positioned to accommodate the Unigas 3000+ probe for raw smoke analysis at the point of entry prior to the first wash chamber. Another was positioned within the sample chamber, well downstream from the second wash chamber, for the purpose of analysing the post wash gases. This configuration allowed a minimal time delay between the individual analyses, thus ensuring uniform smoke conditions for all samples.

### Experimentation—Black Coal

1 kg of crushed black coal was ignited in the stainless steel burner and, with the assistance of a blown air source, was taken to over 385° C. whereupon the smoke effluent became relatively clear. This output was ducted towards the processing unit and analysed using the Unigas 3000+Flue Gas Analyser immediately prior to connection. This sample was labelled the “Raw Coal Smoke” sample.

The ducting tube was then connected to the first wash chamber subjecting the burner output (smoke effluent) to the micro mist produced by three of the misting nozzles. The used residual fluid was collected in the first residual capture unit for further analysis. The washed smoke flowed into the second wash chamber where it was subjected to the micro mist from the fourth spray nozzle. The residual from this chamber was collected in the second residual capture unit for further analysis.

The smoke then entered the sampling chamber and was analysed via the Unigas 3000+ probe at the sample port. This sample was labelled according to the dilution of wash fluid used and the number of spray nozzles employed e.g. “3% 4 spray” sample. The processed smoke was finally released into the atmosphere through the extraction fan.

### Sampling and Analysis

Gas sampling and analysis was conducted using the Unigas 3000+Flue Gas Analyser. The data sought was a comparison between washed and unwashed samples. To ensure that the sample smoke properties remained uniform, a short time span between taking the samples was a prime requirement. The ability of the Unigas 3000+ to self calibrate and continually analyse allowed the samples to be acquired within eight minutes of each other. Consequently the data proved to be sufficiently accurate to provide reliable results for the gases targeted by these experiments.

### Results

| COAL | Raw | 3% × 4 Spray | % Change |
|---|---|---|---|
| O2 | 11.10% | 18.10% | 63.0 |
| CO | 0.12% | 0.10% | 16.67 |
| CO2 | 7.30% | 2.10% | 71.23 |
| NO | 287.00 ppm | 63.00 ppm | 78.05 |
| NOX | 296.00 ppm | 65.00 ppm | 78.04 |
| SO2 | 167.00 ppm | 23.00 ppm | 86.23 |

### Particulates

Although the smoke output from the burner appeared to be relatively clear (Ringleman Standard 1 to 2), the residual sample taken from the first (three spray) wash chamber was unexpectedly dark in comparison with previous tests. The difference in this case was the high temperature of burner burner output. The residual sample from the second wash chamber was also unexpectedly dark, although a sheen of unused wash fluid was evident in the sample. The temperature of the smoke gases in previous experiments had been lower in order to produce a visually smoky output. Additionally, the temperature of the second wash chamber was considerably lower (approaching ambient) than the smoke gases in the first chamber due to the efficient cooling action of the wash fluid. This observation may indicate that the efficiency of the wash process varies with the temperature of the subject flue effluent.

### Example 6

### Adsorption of CO2

Being mindful of CO2 being identified as the prime target in the reduction of Greenhouse Gases, further experiments were conducted to verify the results already obtained for CO2 from the combustion data. Additionally, there was a requirement to determine what part the water component of the solution played in reducing the CO2. As a result the apparatus was modified to accommodate food-standard CO2 diffused into a column of wash agent.

### Method

The wash chamber was filled with 15 litres of water to form a column 100 mm diameter×1500 mm high through which was passed fine bubbles of Food-Grade CO2 via a diffuser situated at the bottom of the column. The CO2 was allowed to flow into and fill the second processing chamber and likewise in turn, the sampling chamber until the reading on the Unigas 3000+analyser stabilised. This reading was taken as a base representing saturation of the apparatus. Without changing the CO2 flow, 450 ml of treatment composition concentrate was injected into the water column. This was rapidly mixed into the water by the rising bubble action of the CO2 and became an active wash agent almost immediately.

Again the CO2 reading on the analyser was allowed to stabilise and was recorded. The difference between this reading and the base reading was taken to indicate the level of CO2 removal of a 3% treatment composition wash fluid under ambient temperatures (32.4° C.).

| CO2 | H2O | 3% | % Change |
|---|---|---|---|
| 15 min | 14.70% | 14.00% | 4.76 |
| 25 min | 15.10% | 5.40% | 64.24 |
| 30 min | 15.30% | 4.70% | 69.28 |
| 40 min | 15.30% | 4.60% | 69.93 |

A similar test was conducted using a 1% treatment composition wash fluid under ambient temperatures (26.7° C.).

| CO2 | H₂O | 1% | % Change |
|---|---|---|---|
| 15 min | 14.70% | 14.00% | 4.76 |
| S25 min | 15.10% | 7.40% | 50.99 |
| 30 min | 15.10% | 6.10% | 59.60 |
| 40 min | 15.10% | 5.90% | 60.93 |

It was observed that the 1% treatment composition wash fluid eventually achieved the same degree of CO2 removal compared to the 3% solution; however it took longer to do so. There is suggestion that the 5.7° C. temperature difference may have been instrumental in this variation however, experience with the 1% solution during other experiments suggest that at 1% dilution a saturation limitation may be the deciding factor. No such delays or loss of performance have been experienced using dilution rates of 3% and above, so further investigations are scheduled to verify this aspect. Nevertheless subsequent experiments concentrated on establishing data for a 3% solution, the preferred dilution.

Regarding the effect of water on the process, as there was only 1.3% difference between the 3% solution coal combustion % change and the 3% solution pure CO2% change, it would appear that water on its own has minimal effect on the CO2 removal. The efficiency of CO2 removal was a particularly surprising discovery by the inventors in relation to the invention.

### Example 7

Diesel fuel was ignited. Considerable difficulty was experienced in obtaining raw smoke data due to the high particulate content of diesel smoke rapidly obstructing the Unigas 3000+ filter. Therefore, to obtain performance indications for treatment composition against diesel smoke, a decision was made to bypass the raw smoke sample. Instead, given the conclusion regarding the effect of water on the chemical pollutant removal process described previously, and assuming the physical action of the water misting spray would reduce the particulates in the diesel smoke to a sufficient degree so as to prevent total obstruction of the Unigas 3000+ filter, a comparison between the results of diesel smoke washed with plain water against those of both 1% and 3% treatment composition wash fluid was sought. In the event, the filter although very dirty, did not choke completely and meaningful results were obtained. Nevertheless, these results are not considered definitive and improvements on the % change figures are anticipated. The broad spectrum efficiency of the present invention was particularly surprising.

| Diesel | H₂O 3 Spray | 1% 3 Spray | 3% 3 Spray | % Change |
|---|---|---|---|---|
| O2 | 15.60% | 17.10% | 18.10% | 13.81 |
| CO | 0.08% | 0.06% | 0.04% | 50.00 |
| CO2 | 4.10% | 2.90% | 2.20% | 46.34 |
| NO | 6 ppm | 5 ppm | 4 ppm | 33.33 |
| NOX | 7 ppm | 5 ppm | 4 ppm | 42.86 |
| SO2 | 90 ppm | 16 ppm | 13 ppm | 85.56 |

The apparatus evolved to the point where consistent data was acquired with an acceptable degree of accuracy.

### Black Coal (Primary Target):

Experiments to remove CO2 from burning black coal produced results varying from 52.6% to 71.2% removed. This variance is thought to be dependent on the temperature of flue gases. Nevertheless, the wash fluid was observed to be very effective at higher temperatures (in the order of 385° C.). Of interest was the ability of treatment composition to reduce the level of CO2 while concurrently reducing the levels of the additional target gases in a “single pass” scenario. The reduction of SO2 by 86% was particularly noteworthy. Additionally, the ability of the treatment composition and method to encapsulate particulates thereby improving the opacity of black coal smoke smoke is very significant.

### Diesel Fuel (Secondary Target):

Experiments to remove CO2 from burning diesel fuel produced results ranging from a 35.7% to a 46.3% reduction when compared to a plain water wash. Reductions of 85.56% of SO2, and 50% of CO under the same “less than optimum conditions”, were very encouraging. Additionally, the ability to remove sooty particulate matter from diesel smoke is substantial

### Particulates:

Samples of post wash residue harvested from the residual capture chamber over a number of experiments was stored undisturbed for some eight months. In that time, the particulates assessed at >8 mg/l had not appeared to settle, the colour of the sample had not changed and sediment was minimal. The conclusion drawn is consistent with the particulates being held in suspension as a result of encapsulation.

### Adsorption or Absorption

From the number and nature of the experiments conducted, there is no doubt that the introduction of a micelle encapsulation wash fluid such as the treatment composition removes CO2, CO, NO, NOx and SO2 from coal and diesel smoke to a greater or less degree. Additionally, the fluid has the ability to remove a high level of particulate matter from the subject smoke. Moreover, because no exothermic activity was experienced during washing and following professional consultation, it is considered that the process may be one of adsorption.

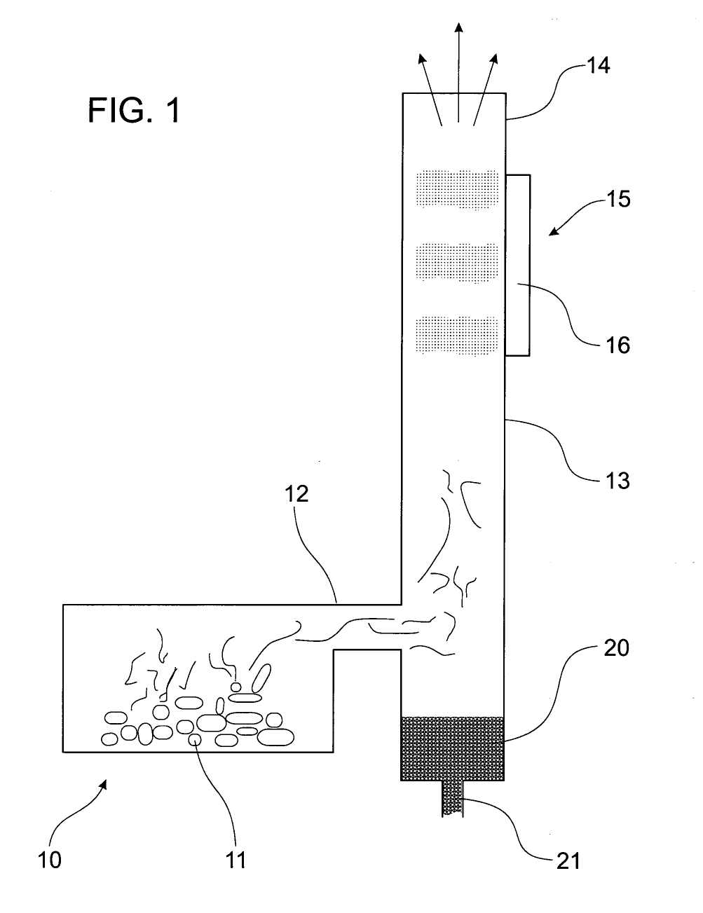

Referring to FIG. 1, there is shown a furnace 10 with combusting materials 11. Smoke is channelled through offtake 12 into stack 13 which is open to the environment at upper end 14.

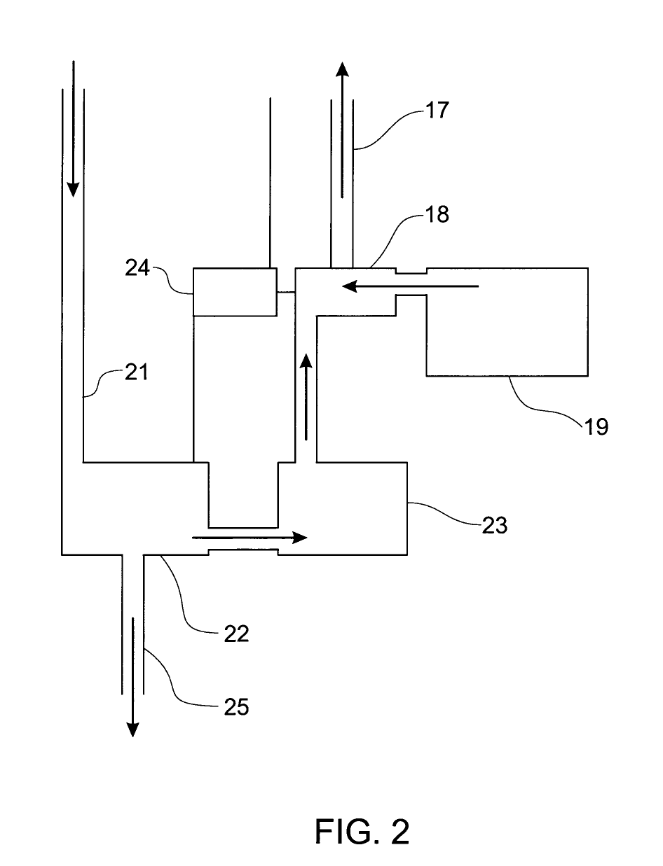

A spray array 15 is positioned along the length of the stack 13 and is fed by manifold 16. A feed pipe 17 is shown in FIG. 2, and is in fluid connection with the manifold and connected to supply pump 18 which draws smoke treating liquid from holding tank or reservoir 19. The spray array may be positioned between the furnace and stack to replace a typical prior art scrubber arrangement.

A trap 20 is provided at the bottom of the stack to collect used wash liquid and entrapped particulates and gases. Trapped liquid may be released and passed through return pipe 21 to treatment centre 22 which, in its simplest form may be a filter arrangement. However, more sophisticated arrangements, as known to those skilled in the art, may also be recruited. Treated wash liquid may then be recirculated to recycle tank 23 and waste material, after separation, disposed of appropriately 25. The whole process is preferably variable. A control unit in the form of a programmable computer control unit 24 is provided. The computer may be linked to sensors such as CO₂ sensors, visual quality sensors and temperature sensors in or near the stack and/or sensors in the holding tank and recycle tank to provide information on concentration and temperature of the treatment liquid. In one embodiment a mixer may be provided for varying the concentration of the final spray solution to better accord with the nature of the exhaust gas.

Similar arrangements with necessary modifications may be used in exhaust systems of motor powered vehicles and other engines.

The present invention provides great and surprising benefits in a particularly important aspect of human undertaking. Using the treatment composition, method and arrangement as set out above, an industrial undertaking may take significant affordable measures to reduce its environmental footprint. While particulate matter is drawn from the smoke there is a major contemporaneous advantage in also lowering levels of the major greenhouse gases. Application of the present invention potentially will provide an important aid in combating one of the major threats to atmospheric quality.

Various changes and modifications may be made to the embodiments described and illustrated without departing from the present invention.

1. A method of treating exhaust gases, the method comprising the steps of:
introducing a treatment composition in a controlled manner to exhaust gases in or near a confined flow path;
wherein:
the treatment composition includes or comprises a micelle encapsulating compound.

2. The method of claim 1 wherein the micelle encapsulating compound comprises or includes an anionic surfactant.

3. The method of claim 1 wherein introducing the treatment composition in a controlled manner includes varying one or more characteristics namely:
varying the concentration of the treatment composition by the addition of water;
varying the rate of introduction of the treatment composition to the exhaust gases;
using sensors to assess one or more of temperature, concentration and flow rate of the exhaust gases, or concentration of one or more pollutants in the exhaust gases and subsequently modifying one of the other characteristics to better treat the exhaust gases.

4. The method of claim 3 wherein the step of sensing the parameters includes the step of providing data to a computer and the step of varying the parameters is controlled by the computer in accordance with one or more algorithms.

5. A method of treating exhaust gases, the method comprising the steps of:
introducing a treatment composition in a controlled manner to exhaust gases in or near a confined flow path;
wherein:
the treatment composition comprises, by volume; from about 4 to about 40 parts of an alkoxylated C₁₆-C₁₈ tertiary amine surfactant, from about 1 to about 15 parts of at least one carboxylic acid having from 4 to 16 carbon atoms; about 1 to 6 parts of at least one of a C₆-C₁₄ alcohol, from 0 to 10 parts of a C₄ and lower alcohol, with the balance being water to create a total of about 100 parts by volume.

6. The method of claim 5 wherein the surfactant is selected from animal based tallow amines and coconut amines.

7. The method of claim 5 wherein the surfactant has 2-10 alkoxy groups per mol.

8. The method of claim 5 wherein the treatment composition comprises, by volume, from about 4 to about 40 parts of an ethoxylated C₁₆-C₁₈ tertiary amine, having 2-10 ethoxy groups per mol, from 1 to about 15 parts of at least one aliphatic carboxylic acid, having from 6 to 12 carbon atoms; from about 1 to about 6 parts of at least one of a C₇-C₁₂ aliphatic alcohol, from 0 to about 10 parts of a C₄ and lower alcohol, and the balance being water, to create a total of about 100 parts by volume.

9. The method of claim 5 wherein the treatment composition comprises 2,2,2-nitrotrisethanol aliphatic acid soap in a proportion of around 9.9%,
amines, tallow alkyl ethoxylated 2-etholhexanonates in a proportion around 45%,
linear aliphatic alcohols in a proportion around 5.1%
water in a proportion around 40% to give a total of 100%.

10. The method of claim 5 further comprising the step of diluting the treatment composition to a range of 0.1% to 6% by adding water.

11. The method of claim 10 wherein the step of diluting the treatment composition is to a concentration of 1%, 3% or 6%.

12. The method of claim 11 wherein applying the treatment composition includes one or more of:
spraying, bubbling, misting, hosing, dripping, or fogging the treatment composition into or through the exhaust gases in the combined flow path.

13. A method of treating exhaust gases for reduction of one or more of carbon dioxide, carbon monoxide, sulphur dioxide, nitric oxide and NO_{X}, the method comprising the steps of:
introducing a treatment composition comprising, by volume; from about 4 to about 40 parts of an alkoxylated C₁₆-C₁₈ tertiary amine surfactant, from about 1 to about 15 parts of at least one carboxylic acid having from 4 to 16 carbon atoms; about 1 to 6 parts of at least one of a C₆-C₁₄ alcohol, from 0 to 10 parts of a C₄ and lower alcohol, with the balance being water to create a total of about 100 parts by volume.

14. The method of claim 13 wherein the treatment composition is 2,2,2-nitrotrisethanol aliphatic acid soap in a proportion of around 9.9%,
amines, tallow alkyl ethoxylated 2-etholhexanonates in a proportion around 45%,
linear aliphatic alcohols in a proportion around 5.1%
water in a proportion around 40% to give a total of 100%.

15. A system for treating exhaust gases, the system comprising:
a confined flow path for exhaust gases;
an application arrangement for applying a treatment composition to the exhaust gases in the confined flow path; and
storage means for storing the treatment composition, the storage in liquid communication with the application arrangement,
wherein:
the treatment composition comprises, by volume; from about 4 to about 40 parts of an alkoxylated C₁₆-C₁₈ tertiary amine surfactant, from about 1 to about 15 parts of at least one carboxylic acid having from 4 to 16 carbon atoms; about 1 to 6 parts of at least one of a C₆-C₁₄ alcohol, from 0 to 10 parts of a C₄ and lower alcohol, with the balance being water to create a total of about 100 parts by volume.

16. The system of claim 15 wherein the confined flow path comprises one of a stack, a chimney, an ancillary chamber, a vent or an exhaust system of a motor vehicle or other internal combustion device; and
the application arrangement comprises a pressurised application system adapted to provide a mist, a spray, a fog, a jet or droplets.

17. The system of claim 16 is further comprising a computer programmed to control application of the treatment composition by one or more of:
a) varying the rate of introduction of the treatment composition;
b) varying the concentration of the treatment composition by addition of a solvent, preferably water;
c) receiving digital signals from sensors in the confined flow path wherein the sensors detect temperature and/or concentration of the exhaust gases and pollutants therein;
d) varying the concentration and/or flow rate of the treatment composition in accordance with variations in temperature and concentration of the exhaust gases and pollutants.
